(19) United States
(12) Patent Application Publication
(10) Pub. No.: US 2025/0290561 A1
(43) Pub. Date: Sep. 18, 2025

(54) A PINION AND A DIFFERENTIAL ASSEMBLY

(71) Applicant: Eaton Intelligent Power Limited, Dublin (IE)

(72) Inventor: Michael David AKER, Auburn, IN (US)

(73) Assignee: Eaton Intelligent Power Limited, Dublin (IE)

(21) Appl. No.: 18/863,158

(22) PCT Filed: May 5, 2023
(86) PCT No.: PCT/EP2023/025216

§ 371 Date: Nov. 5, 2024

Related U.S. Application Data
(60) Provisional application No. 63/338,691, filed on May 5, 2022.

(51) Int. Cl. F16H 48/285; F16H 48/11

(52) U.S. Cl. CPC F16H 48/285; F16H 48/11

(57) ABSTRACT

A side gear rotatable about an axis, the side gear includes a plurality of gear teeth extending laterally therefrom; a casing member rotatable about the axis, the casing member covering the side gear; one or more bores formed in the casing member, the one or more bores extending in a direction parallel to the axis; and one or more pinions, each pinion having an upper surface and a length, being inserted in a corresponding bore of the one or more bores in the direction parallel to the axis, and having one or more pinion teeth extending laterally therefrom, wherein each pinion is configured to mesh with the side gear via the one or more pinion teeth, and wherein along a first portion of the length of the pinion starting from the upper surface thereof, a size of the one or more pinion teeth is greater than a size of the one or more pinion teeth along a second portion of the length of the pinion.

### CROSS-REFERENCE TO RELATED APPLICATIONS

The current application claims the benefit of and priority to U.S. Provisional Application No. 63/338,691, filed on May 5, 2022 and titled “Pinion Support Ring,” the contents of which are herein incorporated by reference in their entirety.

### TECHNICAL FIELD

The present disclosure relates generally to a differential apparatus used for a vehicle or the like, and more particularly to a configuration of the pinion helical teeth.

### BACKGROUND

Requirements for lighter lubricants, e.g., lubricants having lower viscosity, in differential apparatuses continue to evolve. Accordingly, replacing a more viscous lubricant such as a lubricating oil used in a differential mechanism with a less viscous lubricating oil typically comes with reduced surface pressure carrying capacity within the differential mechanism. For example, low viscosity or thin lubricants such as, e.g., oils, typically reduce the surface pressure carrying capacity on portions of the differential that are in frequent contact with each other such as, e.g., pinions and the internal surfaces of their respective bores, due to the use of lubricants with lower viscosity.

### SUMMARY

In one aspect, the technology relates to a side gear rotatable about an axis, the side gear including a plurality of gear teeth extending laterally therefrom; a casing member rotatable about the axis, the casing member covering the side gear; one or more bores formed in the casing member, the one or more bores extending in a direction parallel to the axis; and one or more pinions, each pinion having an upper surface and a length, being inserted in a corresponding bore of the one or more bores in the direction parallel to the axis, and having one or more pinion teeth extending laterally therefrom, wherein each pinion is configured to mesh with the side gear via the one or more pinion teeth, and wherein, along a first portion of the length of the pinion starting from the upper surface thereof, a size of the one or more pinion teeth is greater than a size of the one or more pinion teeth along a second portion of the length of the pinion.

In an example of the above aspect, a lateral surface of the side gear along a length of the side gear that faces the first portion of the length of the pinion is deprived of gear teeth. In an example, the first portion of the length of the pinion is in a range of 10-20% of a total length of the pinion along the direction parallel to the axis. In another example, the first portion of the length of the pinion is about 16% of the total length of the pinion along the direction parallel to the axis.

As another example, a width of the one or more pinion teeth in the first portion of the length of the pinion is 25-40% greater than a width of the one or more pinion teeth in the second portion of the length. In another example of the above aspect, the width of the one or more pinion teeth in the first portion of the length of the pinion is 32.5% greater than the width of the one or more pinion teeth in the second portion of the length. In yet another example, the one or more pinion teeth in the first portion and in the second portion have a helix configuration, and an angle of the helix configuration in the first portion and in the second portion is the same.

In another aspect, the technology relates to a pinion including an upper surface, and one or more pinion teeth extending laterally from the pinion along a length of the pinion in an axial direction thereof, the length including a first portion extending from the upper surface along the axial direction thereof and a second portion extending after the first portion along the axial direction thereof, wherein a size of the one or more pinion teeth in the first portion is greater than a size of the one or more pinion teeth in the second portion. For example, the first portion of the pinion has a length in a range of 10-20% of a total length of the pinion along the axial direction thereof. In an example, the first portion of the pinion has a length of about 16% of the total length of the pinion along the axial direction thereof. In another example, a width of the one or more pinion teeth in the first portion is 25-40% greater than a width of the one or more pinion teeth in the second portion. In yet another example, the width of the one or more pinion teeth in the first portion is 32.5% greater than the width of the one or more pinion teeth in the second portion. In other examples of the above aspect, the one or more pinion teeth have a helix configuration, and an angle of the helix configuration in the first portion and in the second portion is the same.

### BRIEF DESCRIPTION OF THE DRAWINGS

The accompanying drawings, which are incorporated in and constitute a part of the description, illustrate several principles of the present disclosure. A brief description of the drawings is as follows.

FIGS. 1 and 2 are perspective views of a differential apparatus, in accordance with various principles of the present disclosure.

FIG. 3 is a perspective view of a differential apparatus, in accordance with various principles of the present disclosure.

FIG. 4 is an illustration of a differential apparatus, in accordance with various examples of the disclosure.

FIG. 5 is a perspective view of a pinion, in accordance with various principles of the present disclosure.

FIG. 6 is a perspective view of a differential apparatus, in accordance with various principles of the present disclosure.

FIG. 7 is a perspective view of a casing member, in accordance with various examples of the disclosure.

FIGS. 8 and 9 are cross-sections of a differential apparatus, in accordance with various principles of the present disclosure.

FIGS. 10 and 11 are opposite perspective views of a pinion of a differential apparatus, in accordance with various examples of the disclosure.

FIGS. 12-14 are illustrations of a pinion of a differential apparatus, in accordance with various examples of the disclosure.

### DETAILED DESCRIPTION

Due to the reduced surface pressure carrying capacity created by using a lower viscosity lubricant such as, e.g., low viscosity lubricating oil, in differential mechanisms, excessive surface pressures may be generated between a pinion and its respective bore as a result of the use of the low viscosity lubricant. Due to the high surface pressures generated by the friction of the inside surface of the bore with the teeth of a pinion, damage to the inside surface of a bore may be generated by the friction between the teeth of a pinion, or more specifically the teeth tips of the pinion, and the inside surface of the bore within which the pinion is arranged. Accordingly, by increasing the surface area of, e.g., the tooth tip of a pinion, the surface pressure at the interface between the pinion and the inside surface of the bore may be reduced. Various examples of the disclosure include pinions having teeth with enlarged base circle diameters, which result in wider teeth of the pinions. In other examples, the wider teeth may be provided for a first portion of the pinion, while the remaining portion of the pinion may keep their original width, which is narrower than the width of the teeth in the first portion. In an example, along a first length of the pinion along its axis, the teeth are wider than along a remaining length of the pinion, although alternatives are possible.

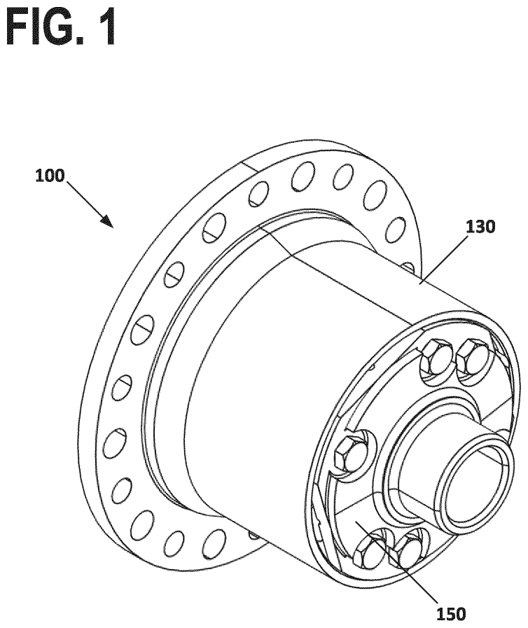

FIGS. 1 and 2 are perspective views of a differential apparatus, in accordance with various principles of the present disclosure. In FIGS. 1 and 2, which are opposite perspective views of a differential apparatus 100, the differential apparatus 100 includes a casing member 130 having an upper covering member 140 and a lower covering member 150. Further details of the differential apparatus 100 are provided below.

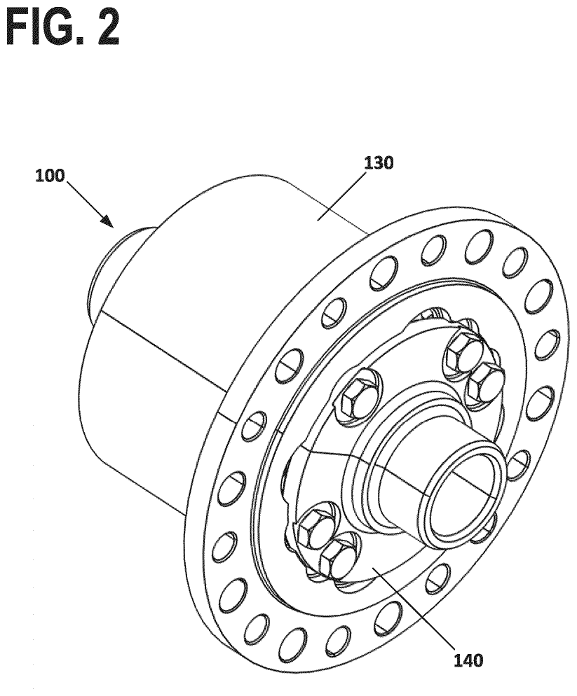

FIG. 3 is a perspective view of a differential apparatus, in accordance with various principles of the present disclosure. In FIG. 3, the differential apparatus 100 includes a plurality of pinions 110 and 120 meshed around a same side gear 115, and fastening holes 135 of the casing member 130. The pinions 120 are different from the pinions 110. For example, for any pinion 110, the teeth thereof have a uniform size along the length of the pinion 110. In contrast, for any pinion 120, the teeth thereof do not have a same size along the length thereof. As further discussed below, the teeth at a portion of the pinion 120 that is configured to engage with the side gear 115 by an upper surface of the casing member 130 have a larger size than the teeth of the pinion 120 located further from the upper surface of the casing member 130. Further details on the sizes of the teeth of the pinions 120 are further discussed below.

The side gear 115 and the pinions 110 and 120 are coupled to the surface of the casing member 130 of the differential apparatus 100. The casing member 130 has a generally circular shape and includes a plurality of bores 132. The side gear 115 may be arranged along a central axis of the circle formed by the perimeter of the casing member 130, and the pinions 110 and 120 may be arranged around the side gear 115. In an example, a central axis of each pinion 110 and 120 may be arranged so that the pinions 110 and 120 are equidistantly circumferentially arranged around the side gear 115. For example, the side gear 115 may be configured to mesh with each of the pinions 110 and 120 so as to cooperate therewith during operation of the differential apparatus 100. Teeth of the side gear 115 (not shown) are configured to mesh with teeth of each of the pinions 110 and 120 (not shown) during operation of the differential apparatus 100. The differential apparatus 100 also includes an upper covering member 140 and a lower covering member 150 configured to be fixed to the casing member 130 with the pinions 110 and 120 and side gear 115 therein via a plurality of bolts of fastening members 160.

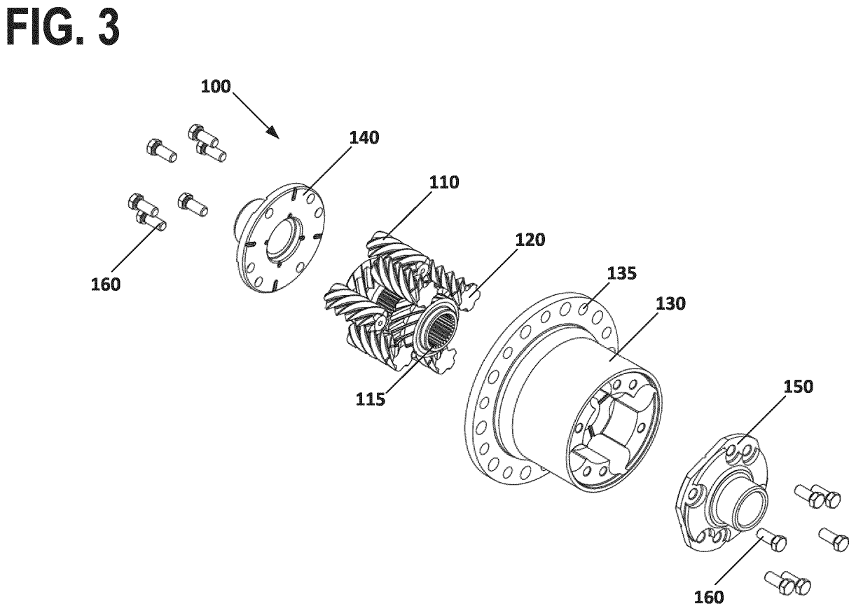

FIG. 4 is a more detailed illustration of a side gear 115 meshed with a plurality of pinions 110 and 120, in accordance with various examples of the disclosure. In FIG. 4, the differential apparatus 100 includes side gear 115 in a meshed cooperation with the plurality of pinions 110 and 120. With reference to FIG. 3, the side gear 115 and the pinions 110 and 120 are coupled to the upper surface of the casing member 130, the side gear 115 may be arranged along a central axis of the circle formed by the upper surface of the casing member 130, and the pinions 110 and 120 are arranged around the side gear 115 in the bores 132 formed in the casing member 130.

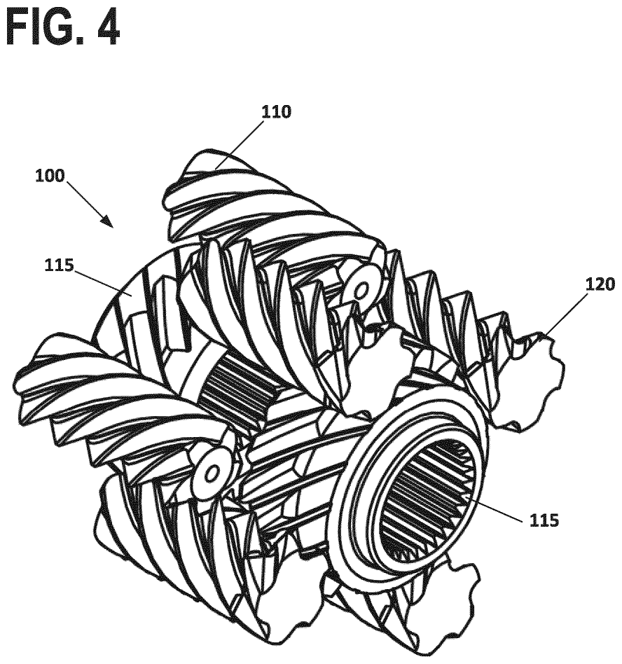

FIG. 5 is a perspective view of a side gear and pinions arrangement, in accordance with various principles of the present disclosure. In FIG. 5, the side gear 115 is in a coupling or mating configuration with one or more pinions 110 and one or more pinions 120. Each pinion 110 has helical teeth thereon that have a same size along substantially the entire length of the pinion 110. Each pinion 120 has helical teeth 122 and 125 of differing sizes along the length thereof. For example, each pinion 120 has helical teeth 125 of a given size along portion 124 of the entire length of the pinion 120, and helical teeth 122 of a size that is larger than the size of teeth 125 along portion 128 of the entire length of the pinion 120. Both types of pinions 110 and 120 are in a mating configuration with side gear 115.

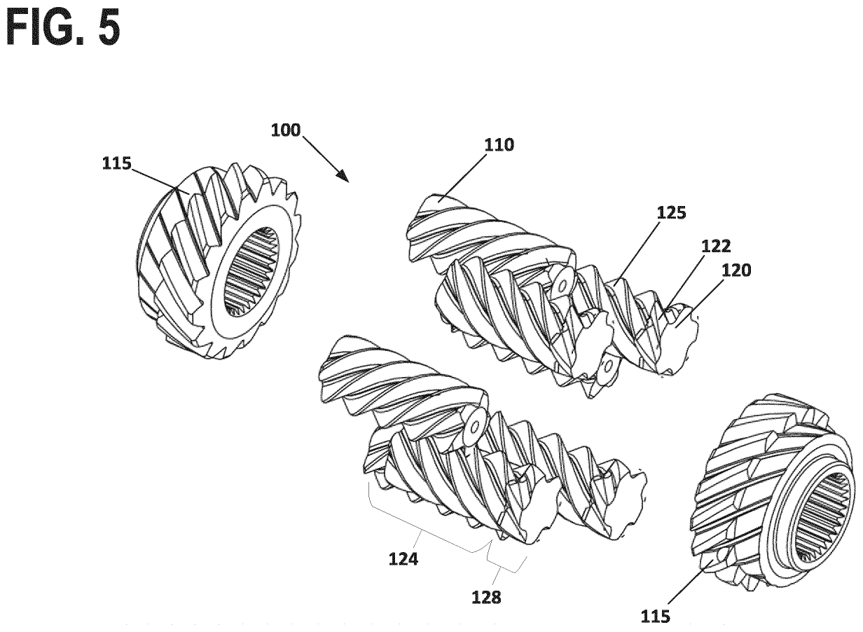

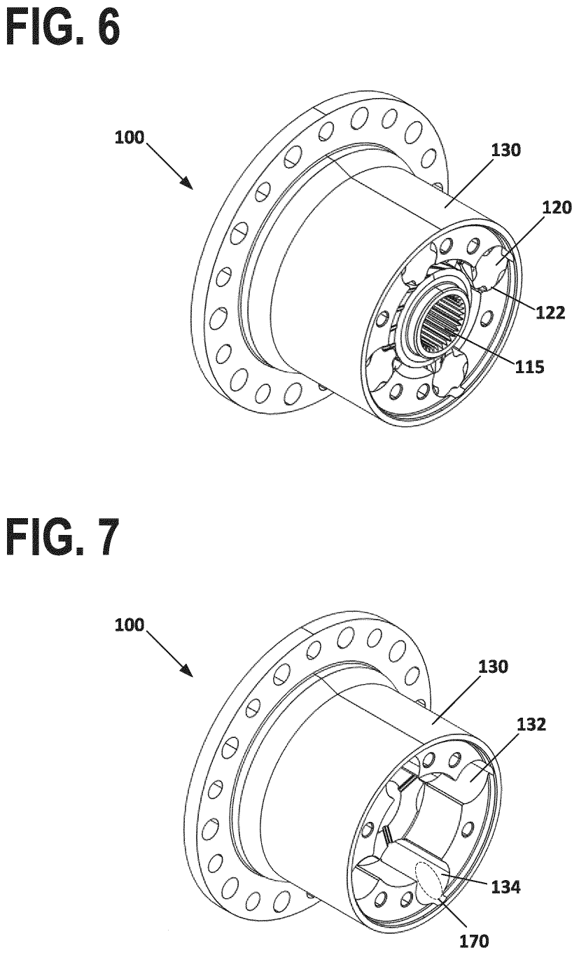

FIG. 6 is a perspective view of a differential apparatus, in accordance with various principles of the present disclosure. In FIG. 6, the differential apparatus 100 includes casing member 130 and pinions 120 inserted in bores 132 (illustrated in FIG. 7) formed inside the casing member 130. In examples, each of the pinions 120 includes a plurality of teeth 122, similar to the pinion teeth 122 discussed above with respect to FIG. 5. The side gear 115 is coaxially located within the casing member 130 of the differential apparatus 100. At the surface of the casing member 130, the side gear 115 is configured to mate or interlock with the pinion teeth 122 of the pinions 120.

FIG. 7 is a perspective view of a casing member 130, in accordance with various examples of the disclosure. In FIG. 7, the casing member 130 includes a plurality of bores 132, each of the bores 132 having an inside surface 134 configured to receive, e.g., a pinion such as pinion 120. The inside surface 134 may undergo excessive wear during operation of the differential apparatus 100 due to friction between the inside surface 134 and the pinion teeth 122 inserted therein, and the area of friction between the teeth 122 of the pinion 120 and the inside surface 134 of the bore 132 is highlighted in area 170. In various examples, it is the portion 170, corresponding to the interface between the teeth 122 of the pinion 120 and the inside surface 134 of the bore 132, that suffers wear and general degradation because of the excessive surface pressures generated between the teeth 122 of the pinion 120 and the inside surfaces 134 of their respective bores 132, and because of the use of a low viscosity lubricant therebetween.

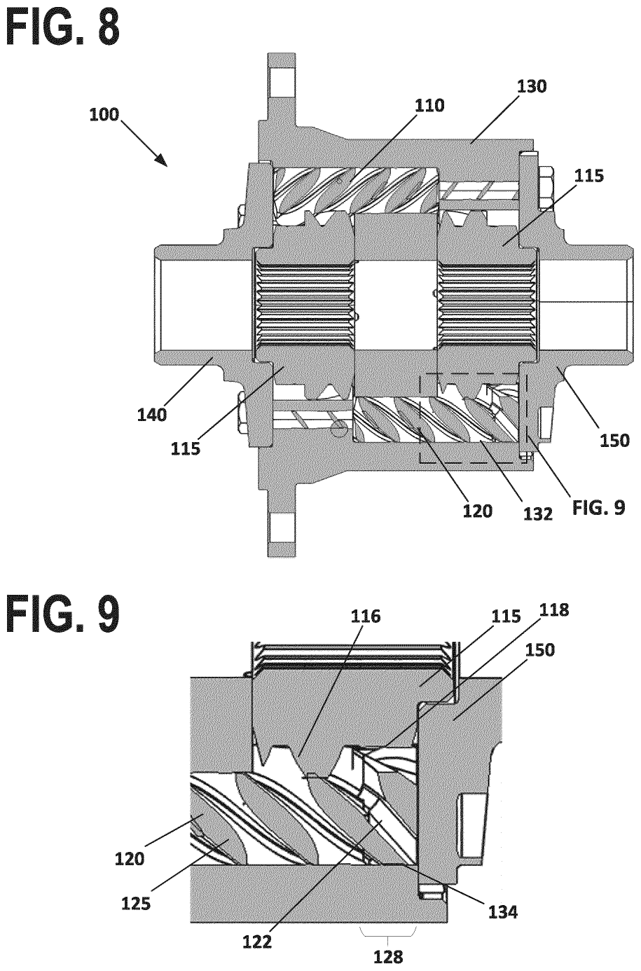

FIGS. 8 and 9 are cross-sections of a differential apparatus, in accordance with various principles of the present disclosure. FIGS. 8 and 9 are described concurrently and not every component described is depicted in every figure, and FIG. 9 is an enlarged view of portion 9 in FIG. 8. The differential apparatus 100 includes a side gear 115 and a plurality of pinions 110 and 120 configured to mate or interlock with the side gear 115. In examples, each pinion 120 includes a first portion 128 along a length thereof, where the pinion teeth 122 are larger than the pinion teeth 125 in the remaining of the length of the pinion 120. In contrast, each pinion 110 has pinion teeth with the same size along the entire length of the pinion 110. In other examples, the side gear 115 includes a lateral surface 118 facing the pinion portion 128 when the side gear 115 and the pinion 120 are engaged in a mating configuration. For example, the lateral surface 118 of the side gear 115 does not have any teeth thereon, while another portion of the side gear 115 has side gear teeth 116 thereon. In various examples, interlocking or mating of the side gear 115 with the pinions 120 is performed by the pinion teeth 125 mating or interlocking with corresponding side gear teeth 116, and the lateral surface 118 of the side gear 115 that faces the portion 128 of the pinion 120 does not include any teeth thereon. In the area between the lateral surface 118 of side gear 115 and the portion 128 of the pinion 120, no side gear teeth are present.

The lack of teeth between the lateral surface 118 of the side gear 115 and the portion 128 of the pinion 120 allows to avoid creating friction between the side gear 115 and the pinion 120 at the portion 128, which may be advantageous because if the lateral surface 118 of the side gear 115 included side gear teeth, then mating between such side gear teeth and the larger pinion teeth 122 of the pinion 120 may not be possible and may result in degrading operation of the differential apparatus 100. Accordingly, because the lateral surface 118 of the side gear 115 does not include any side gear teeth, operation of the differential apparatus 100 may continue to take place properly even when a same pinion 120 includes teeth 122 in one portion 128 that are larger than pinion teeth 125 in another portion 124.

In various examples, for a given pinion 120, the length of the portion 128 thereof that includes the larger pinion teeth 122 may be in a range of 10-20% of the total length of the pinion 120. In another example, the length of the portion 128 of the pinion 120 that includes the larger pinion teeth 122 may be about 16% of the total length of the pinion 120.

In various examples, as a result of the larger teeth 122 present in the portion 128 of the pinions 120, there is less friction generated between the pinion teeth 122 and the interior surface 134 of the bore 132 in which the pinion 120 is inserted. As a result, a decrease in the surface pressure at the interface between the bore 132 and the pinion 120 may be achieved, even when low viscosity lubricants are used. Accordingly, even when using lubricants with low viscosity, the integrity of the interior surface 134 of the bores 132 in which the pinions 120 are inserted may be substantially preserved, or may have a longer useful life.

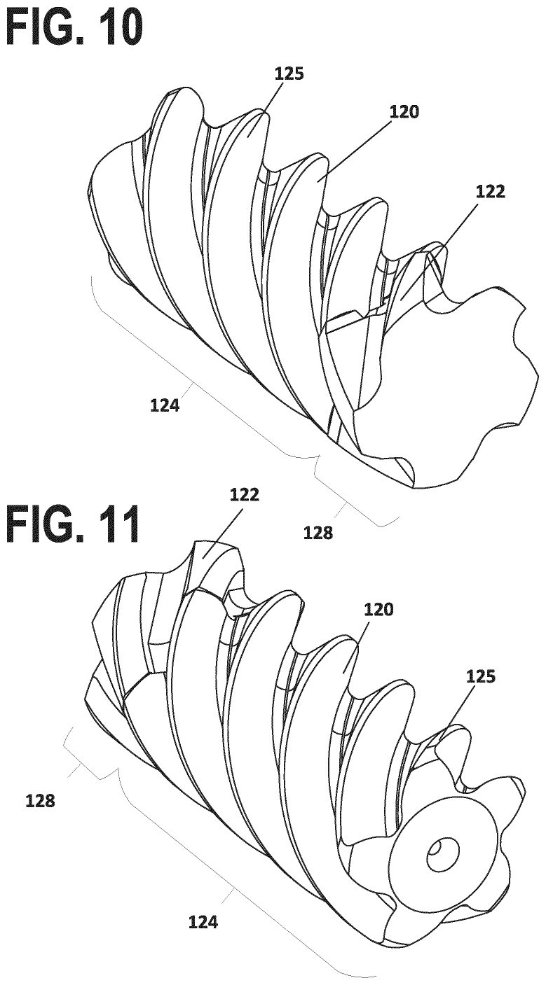

FIGS. 10 and 11 are opposite perspective views of a pinion 120 of a differential apparatus, in accordance with various examples of the disclosure. In FIGS. 10 and 11, the pinion 120 includes a portion 124 where the teeth 125 are smaller than the teeth 122 at another portion 128 of the pinion 120.

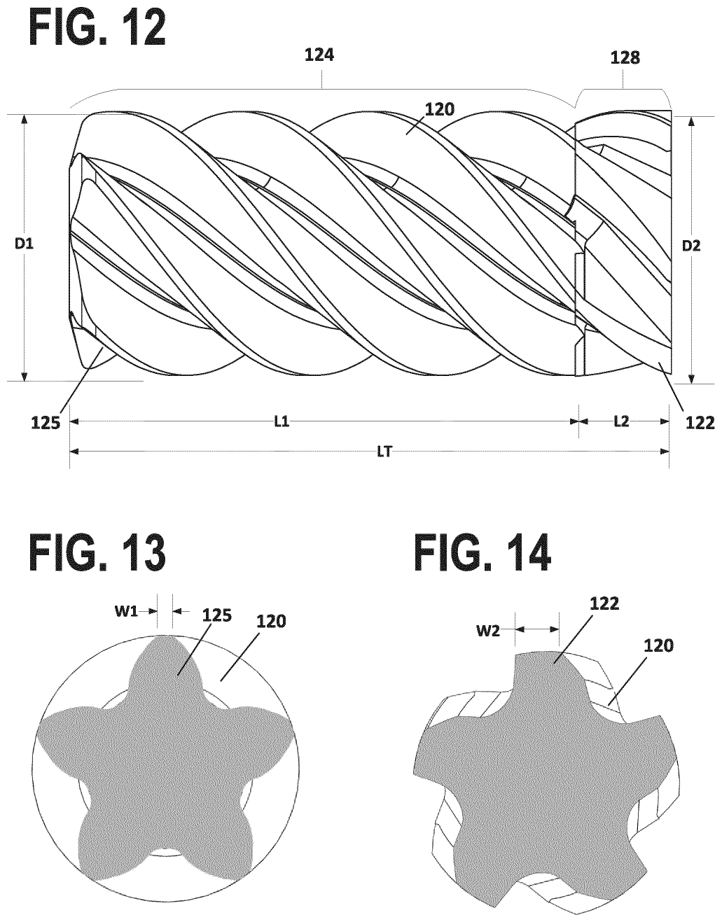

FIGS. 12-14 are various views of a pinion 120 in accordance with various examples of the disclosure. FIG. 12 illustrates a cross-section of the pinion 120, in accordance with examples of the disclosure. In FIG. 12, diameters D1 and D2 of both ends of the pinion 120 are substantially equal to each other. However, FIG. 12 also shows that the size of the teeth 125 and 122 may be different. For example, teeth 125 of a given size extend to a length L1 of the total length LT of the pinon 120, and teeth 122 of a size greater than teeth 125 extend to a length L2, which corresponds to region 124, on the opposite side of the total length LT of the pinon 120. FIGS. 13 and 14 illustrate side views of the pinon 120, in accordance with various examples. FIG. 13 illustrates the portion of the pinion 120 that includes the teeth 125 which have a width w1. FIG. 14 illustrates the portion of the pinion 120 that includes the teeth 122 which have a width w2. In various examples, the width w2 of teeth 122 is greater than the width w1 of teeth 125. In various examples, the width w2 is more than twice as great as width w1. In the example shown, the width w2 is about three times as great as the width w1. Although FIG. 12 shows that the larger sized teeth 122 extend over a length L2 that is smaller than the length L1, which corresponds to portion 128, for the smaller sized teeth 125, in other examples, the length L2 may be equal to, or larger, than the length L1. The portion 128 or length L2 may constitute between 10% and 20% of the total length LT of the pinion 120. As another example, the portion 128 constitutes between 25% and 33% of the total length LT of the pinion 120. In one example, the portion 128 constitutes 16% of the total length LT of the pinion 120.

With respect to the size of the teeth 122 compared to the size of the teeth 125, in various examples, the size of the pinion teeth 122 in the portion 128 is about 25-40% greater than the size of the pinion teeth 125 in the portion 124 of the pinion 120, although alternatives are possible. In another example, the size of the pinion teeth 122 in the portion 128 is about 32.5% greater than the size of the pinion teeth 125 in the portion 124 of the pinion 120, although alternatives are possible. As a result, a reduction in the load capacity when lower viscosity lubricants are used may be up to 24.5%. Alternatively, a gear tooth tip area, or area of the outer diameter, of the pinion teeth 125 may be greater than the gear tooth tip area of the pinion teeth 122 by about 32.5%. In other examples, the difference between the gear tooth tip areas of the teeth 125 and 122 may be in a range of 25-40%.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Various modifications and alterations of this disclosure will become apparent to those skilled in the art without departing from the scope and spirit of this disclosure, and it should be understood that the inventive scope of this disclosure is not to be unduly limited to the illustrative examples set forth herein.

1. A differential apparatus comprising:
a side gear rotatable about an axis, the side gear comprising a plurality of gear teeth extending laterally therefrom;
a casing member rotatable about the axis, the casing member covering the side gear;
one or more bores formed in the casing member, the one or more bores extending in a direction parallel to the axis; and
one or more pinions, each pinion having an upper surface and a length, being inserted in a corresponding bore of the one or more bores in the direction parallel to the axis, and having one or more pinion teeth extending laterally therefrom;
wherein each pinion is configured to mesh with the side gear via the one or more pinion teeth; and
wherein along a first portion of the length of the pinion starting from the upper surface thereof, a size of the one or more pinion teeth is greater than a size of the one or more pinion teeth along a second portion of the length of the pinion.

2. The differential apparatus of claim 1, wherein a lateral surface of the side gear along a length of the side gear that faces the first portion of the length of the pinion is deprived of gear teeth.

3. The differential apparatus of claim 1, wherein the first portion of the length of the pinion is in a range of 10-20% of a total length of the pinion along the direction parallel to the axis.

4. The differential apparatus of claim 3, wherein the first portion of the length of the pinion is about 16% of the total length of the pinion along the direction parallel to the axis.

5. The differential apparatus of claim 1, wherein a width of the one or more pinion teeth in the first portion of the length of the pinion is 25-40% greater than a width of the one or more pinion teeth in the second portion of the length of the pinion.

6. The differential apparatus of claim 5, wherein the width of the one or more pinion teeth in the first portion of the length of the pinion is 32.5% greater than the width of the one or more pinion teeth in the second portion of the length of the pinion.

7. The differential apparatus of claim 1, wherein the one or more pinion teeth in the first portion and in the second portion have a helix configuration, and an angle of the helix configuration in the first portion and in the second portion is the same.

8. A pinion comprising:
an upper surface; and
one or more pinion teeth extending laterally from the pinion along a length of the pinion in an axial direction thereof, the length comprising a first portion extending from the upper surface along the axial direction thereof and a second portion extending after the first portion along the axial direction thereof;
wherein a size of the one or more pinion teeth in the first portion is greater than a size of the one or more pinion teeth in the second portion.

9. The pinion of claim 8, wherein the first portion of the pinion has a length in a range of 10-20% of a total length of the pinion along the axial direction thereof.

10. The pinion of claim 9, wherein the first portion of the pinion has a length of about 16% of the total length of the pinion along the axial direction thereof.

11. The pinion of claim 8, wherein a width of the one or more pinion teeth in the first portion is 25-40% greater than a width of the one or more pinion teeth in the second portion.

12. The pinion of claim 11, wherein the width of the one or more pinion teeth in the first portion is 32.5% greater than the width of the one or more pinion teeth in the second portion.

13. The pinion of claim 8, wherein the one or more pinion teeth have a helix configuration, and an angle of the helix configuration in the first portion and in the second portion is the same.

14. The differential apparatus of claim 1, wherein an area of an outer diameter of the one or more pinion teeth in the first portion of the length of the pinion is 25-40% greater than an area of an outer diameter of the one or more pinion teeth in the second portion of the length of the pinion.

15. The pinion of claim 8, wherein an area of an outer diameter of the one or more pinion teeth in the first portion is 25-40% greater than an area of an outer diameter of the one or more pinion teeth in the second portion of the length of the pinion.

16. A differential apparatus comprising
a side gear rotatable about an axis, the side gear comprising a plurality of gear teeth extending laterally therefrom;
a casing member rotatable about the axis, the casing member covering the side gear;
one or more bores formed in the casing member, the one or more bores extending in a direction parallel to the axis; and
one or more pinions, each pinion having an upper surface and a length, being inserted in a corresponding bore of the one or more bores in the direction parallel to the axis, and having one or more pinion teeth extending laterally therefrom;
wherein each pinion is configured to mesh with the side gear via the one or more pinion teeth;
wherein the one or more pinions includes a first plurality of pinions and a second plurality of pinions, the first plurality of pinions having different sized teeth along the length of the pinion;
and wherein the side gear includes a lateral surface without gear teeth.

17. The differential assembly of claim 16, wherein size of the teeth are varied by at least the width of the teeth at the upper surface, and wherein the width of the upper surface is greater at a first portion of first plurality of pinions than the upper surface of the second portion of the first plurality of the pinions.

18. The differential assembly of claim 16, wherein the lateral surface faces the first portion when the side gear and the first plurality of pinions are engaged in a mating configuration.

19. The differential assembly of claim 18, wherein the pinion and bore are configured such that the size of the first portion within the bore generates less friction between the teeth of the first portion and an interior surface of the bore.

20. The differential assembly of claim 16, wherein an area of an outer diameter of the one or more pinion teeth in a first portion of the length of the first plurality of pinions is 25-40% greater than an area of an outer diameter of the one or more pinion teeth in the second portion of the length of the first plurality of pinions.
